(19) United States
(12) Patent Application Publication
(10) Pub. No.: US 2010/0110515 A1
(43) Pub. Date: May 6, 2010

(54) NOTCH FILTER SYSTEM

(75) Inventors: Sébastien Blais-Ouellette, Laval (CA); Daniel Gagnon, Chambly (CA); Jean-François Moquin, Laval (CA); Marc Verhaegen, Laval (CA)

Correspondence Address: Photon etc., 5795 De Gaspe Avenue, #222, Montreal, QC, H2S 2X3, CA

(73) Assignee: PHOTON ETC., INC., Montreal, QC (CA)

(21) Appl. No.: 12/529,857

(22) PCT Filed: Mar. 7, 2008
(86) PCT No.: PCT/CA2008/000463

§ 371 Date: Sep. 3, 2009

Related U.S. Application Data
(60) Provisional application No. 60/905,587, filed on Mar. 8, 2007.

(51) Int. Cl. G02B 5/32

(52) U.S. Cl. 359/15

(57) ABSTRACT

A notch filter system, where multiple filter passes of a light signal may be effected for removing a target spectral component from the light signal, is provided. Advantageously, the notch filter system may be tunable. A cascade notch filter system is provided which includes multiple notch filters arranged in a cascade, each of the filters having spectral filtering characteristics and being disposed in the path of the light signal at an appropriate filter angle so that the target spectral component is filtered out of the light signal as the light signal passes therethrough. A multipass notch filter system is provided which includes a notch filter having spectral filtering characteristics, and an optical assembly for directing the light signal for multiple filter passes through the filter at an appropriate angle, so that the target spectral component is filtered out of the light signal as the light signal passes through the filter.

### FIELD OF THE INVENTION

The present invention relates generally to spectral filtering of light, and more particularly to holographic filters used to attenuate or filter out light in a given wavelength band.

### BACKGROUND OF THE INVENTION

In signal processing, filters that pass most wavelengths of light unaltered but stop to certain wavelengths in a specific range or band are referred to as band-stop filters. A notch filter is a band-stop filter which attenuates a narrow range or band of wavelengths.

Notch filters have particularly important applications in astronomical imaging, telecommunication, biophotonic equipment, removing unwanted fluorescence, and Raman spectroscopy.

Near-infrared emission from atmospheric hydroxyl (OH) radicals is known to severely affect astronomical observations. Notch filters with a large number of narrow reflecting wavelength bands well-matched to OH spectral lines can be used to remove this unwanted background, thereby allowing for an ideally black sky to be observed.

In Raman spectroscopy, it is a laser beam of wavelength λ₀ (i.e. a monochromatic light source) which is incident on the material under test. The incident laser beam is scattered by the material into multiple light beams. The majority of the scattered light beams have undergone elastic scattering and have the same wavelength λ₀ as the incident light beam. A very small fraction of the scattered beams have undergone inelastic scattering and have a wavelength λ_{S} different from the wavelength λ₀ of the incident light beam. The inelastic scattered light beams, also referred to as the Raman spectrum, reveal characteristic vibration frequencies of the atoms making up the test material, and thus contain information about the chemical composition and structure of the material. Consequently, the inelastic scattered light beams are the signal of interest and the elastic scattered light beams constitute noise. In order to accurately measure the inelastic scattered light signal, which is orders of magnitude weaker than the elastic scattered light signal, the elastic scattered light beams must be filtered out along with other noise sources. Notch filters are used to block light of wavelength λ₀ and thus the elastic scattered laser light beams.

The quality of the notch filter is determined primarily by its bandwidth (B) and maximum optical density (OD). The bandwidth of the filter determines the smallest difference in wavelength that can be distinguished at a given wavelength. The optical density is the absorbance/attenuation of the filter for a given wavelength per unit distance, i.e. the distance the light travels through the filter material.

Multilayer thin film notch filters available commercially operate on the principle of Bragg interference and are generally used in reflection mode. Wavelengths at or near the Bragg wavelength λ_{B} interfere constructively with each other and consequently have a high reflectivity whereas other wavelengths interfere destructively and consequently have a low reflectivity.

The wavelength selectivity of multilayer thin film notch filters is dependent on the quality and number of layers in the film. The deposition of each layer has to be well controlled. Each layer adds to the cost of the filter. Commercially available multilayer thin film notch filters are limited in thickness to a couple of tens of micrometers. Single band filters with up to one hundred layers have been fabricated for use in the telecommunication industry. The full-width at half-maximum (FWHM) of these filters has reached 0.2 nm. However, to date, 120 mm wafers with 100 layers exhibit good homogeneity over only 7% of the surface of the filter. Due to the limitation on the number of layers, multilayer thin film notch filters have a bandwidth which is too large for many spectroscopic applications, including the suppression of the narrow band lines of OH radicals in astronomical imaging and Raman spectral analysis.

Another drawback of multilayer thin film filters stems from the periodic step variation of its index of refraction. The step profile of its refractive index creates unwanted harmonics and secondary maxima that can be confused with the spectral lines under analysis. Rugate thin film filters, which use a sinusoidal variation of the refractive index rather than a step variation, may be used to overcome this problem, but can be prohibitively expensive.

In contrast to multilayer thin film filter technology, holographic filter technology inherently provides many thousands of layers enabling the design of complex filter profiles not possible with thin film deposition. A volume phase holographic (VPH) notch filter (also called Volume Bragg grating (VBG)) is basically a three-dimensional (3-D) recording of Bragg planes in a photosensitive medium operating on the Bragg interference principle. A VPH notch filter may be used in transmission or reflection mode. The 3-D nature of a volume hologram offers high diffraction efficiency (close to 100%), high wavelength selectivity and the ability to multiplex multiple holograms (e.g. multiple Bragg gratings) in the same volume. VPH notch filters of much greater thickness and uniformity than multilayer counterparts are possible, and hence VPH notch filters with high optical densities are achievable. Moreover, the variation of refractive index in holographic filters can be sinusoidal and thereby not exhibiting the extraneous wavelength bands produced by multi-layer thin film filters. A good basic reference is H. Kogelnik, “Coupled Wave Theory for Thick Hologram Gratings”, Bell Syst. Tech. J. 48, 2909-2947 (1969).

Another inherent advantage of holographic filters is their relative robustness. Multilayer thin film filters have a fragile coating unlike holographic filters, which are either made of glass or encapsulated between glass plates.

Conventional volume phase holographic fitters are usually recorded on dichromated gelatin (DCG) which allows high diffraction efficiency over a broad wavelength band. However, the nature of gelatin and the process of fabrication of the filter limits not only the long-term stability of the filter but the thickness of the filter as well, and thus the narrowness and attenuation of the stopband. They are therefore unsuitable for a lot of potential applications of notch filters.

There is therefore a need for a cost-efficient notch filter system for use in spectroscopic applications that provides enhanced wavelength selectivity while maintaining a high attenuation of the stopband.

### SUMMARY OF THE INVENTION

In accordance with one aspect of the invention, there is provided a cascade notch filter system for removing a target spectral component from a light signal. The cascade notch filter system includes multiple notch filters arranged in a cascade, each of the multiple notch filters having spectral filtering characteristics and being disposed in the path of the light signal so that the light signal forms a filter angle with respect to a normal of the corresponding notch filter, the spectral filtering characteristics and the filter angle being jointly selected for each notch filter so that the target spectral component is filtered out of the light signal as the light signal passes therethrough.

Preferably, each one of the multiple notch filters is a volume phase holographic notch filter.

The cascade notch filter system may further include index-matching prisms sandwiched between consecutive notch filters of the multiple notch filters.

The cascade notch filter system may further include tuning means for tuning the target spectral component filtered out by the system, the tuning means including a holder for holding and jointly adjusting filter angle of each of the multiple notch filters.

In accordance with one embodiment of the cascade notch filter system, the filtering characteristics and filter angle are different for consecutive notch filters of the cascade.

In accordance with another embodiment of the cascade notch filter system, the filtering characteristics and filter angle are the same for consecutive notch filters of the cascade, the consecutive notch filters extending non-parallel to each other.

In accordance with another aspect of the invention, there is provided a multipass notch filter system for removing a target spectral component from a light signal. The multipass notch filter system includes:
a notch filter having spectral filtering characteristics; and
an optical assembly for directing the light signal through the notch filter for multiple passes, the optical assembly directing the light beam onto the notch filter at a same filter angle with respect to a normal of the notch filter at each of the multiple passes, the spectral filtering characteristics and the filter angle being jointly selected so that the target spectral component is filtered out of the light signal as the light signal passes through the notch filter.

The optical assembly may include a pair of reflective components positioned on either side of the notch filter. Preferably, each of the pair of reflective components is a prism cube corner.

The multipass notch filter system may include a leak-tight cell encapsulating the notch filter and optical assembly, the leak-tight cell including two parallel transparent walls for receiving the light signal and outputting a filtered light signal, the leak-tight cell being filled with an index matching liquid.

The multipass notch filter system may include additional notch filters and a rotating filter mount for mounting the notch filter and the additional notch filters thereon and moving one of the notch filters in a path of the light signal.

Other features and advantages of the present invention will be better understood upon reading of preferred embodiments thereof with reference to the appended drawings.

### BRIEF DESCRIPTION OF THE DRAWINGS

FIG. 1A is a schematic representation of a perspective view of a cascade notch filter system according to an embodiment of the invention, showing multiple notch filters arranged in a cascade.

FIG. 1B is a perspective view of a holder for a cascade notch filter system, according to one embodiment of the invention.

FIG. 2 is a schematic representation of a side view of a cascade notch filter system according to another embodiment of the invention.

FIG. 3 is a schematic representation of a perspective view of a multipass notch filter system according to an embodiment of the invention.

FIG. 4A is a schematic representation of a top view of the multipass notch filter system shown in FIG. 3.

FIG. 4B is a schematic representation of a top view of a multipass notch filter system according to an embodiment of the invention.

FIG. 5 is an exploded view of a multipass notch filter system according to an embodiment of the invention.

FIG. 6 is a perspective view of the assembled notch filter system of FIG. 5, showing multiple passes of the light signal therethrough.

### DESCRIPTION OF PREFERRED EMBODIMENTS OF THE INVENTION

In the following description, the term “light” is used to refer to all electromagnetic radiation, including visible light. Furthermore, the term “optical” is used to qualify all electromagnetic (EM) radiation, including light in the visible, infrared and ultraviolet regions of the EM radiation spectrum.

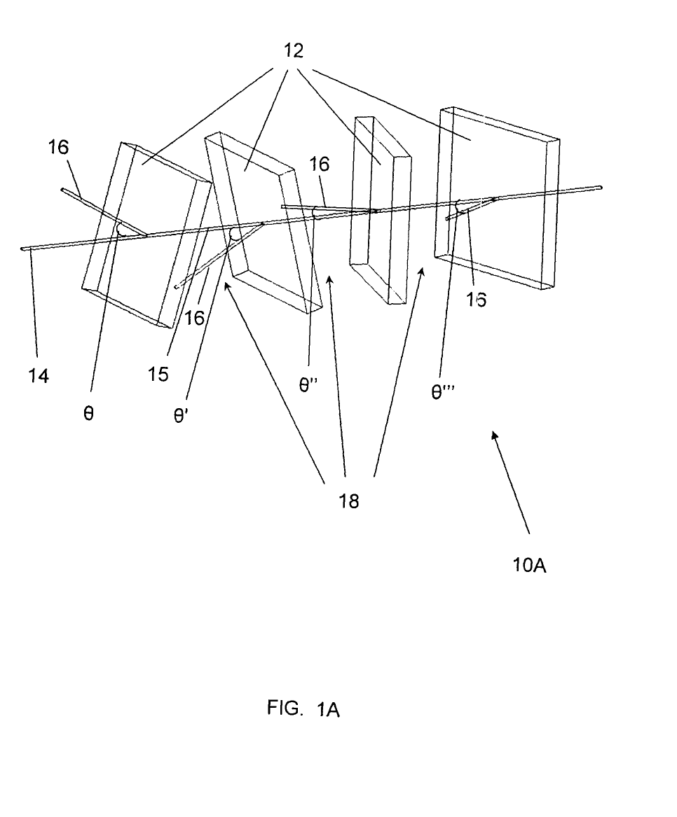

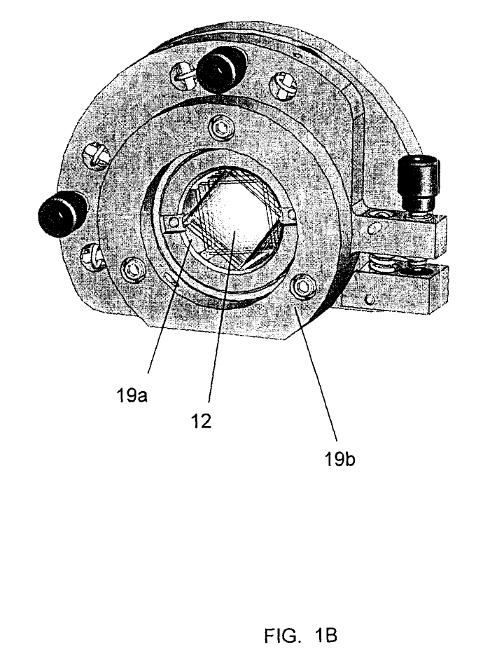

The aspects of the present invention will be described more fully hereinafter with reference to the accompanying drawings FIGS. 1 to 6 in which like numerals refer to like elements throughout.

Generally, the invention provides a notch filter system for removing a target spectral component from a light signal. As mentioned above, notch filters are required for multiple applications such as, but not limited to, astronomical imaging, telecommunication, biophotonic equipment, removing unwanted fluorescence, and Raman spectroscopy. The light signal can therefore be any electromagnetic radiation analysed or generated in such a context. The expression “target spectral component” is understood to refer to a specific wavelength or a narrow band about a specific wavelength which needs to be filtered out of the light signal.

The notch filter system includes at least one notch filter. Preferably, the notch filter zo is a volume phase holographic (VPH) notch filter which is understood to refer to a three-dimensional (3-D) photosensitive volume in which the index of refraction varies periodically to set up a Bragg condition. Because VPH filters operate on the Bragg interference principle, they are also referred to as volume Bragg gratings (VBGs). The photosensitive medium is advantageously made of doped glass such as photo-thermo-refractive (PTR) glass or other material of equivalent properties. VPH filters made of glass, as opposed to those made of dichromated gelatin (DCG), are relatively more stable over a large temperature range and show virtually no degradation after prolonged exposure to elevated work environment temperature, e.g. the FWHM of the center wavelength of the filter shows no degradation after more than several hundreds of hours at 150° C. In addition, VPH filters made of PTR glass are thicker than their DCG counterparts (exhibiting a thickness of several millimetres (mm)) and thereby have a narrower rejection bandwidth (the FWHM of the center wavelength of the filter can be as narrow as a few cm⁻¹). It is however understood that the choice of filter or material may differ depending on the requirements of a particular application.

As mentioned above, current conventional glass VPH notch filters by themselves do not generally provide attenuation levels sufficient for applications such as Raman spectroscopy, for example. This issue is addressed in the system of the present invention by providing multiple filtering of the light signal, each time filtering out the same target wavelength component. This may be achieved by either having the light signal make multiple passes through a same VPH notch filter, or by directing it through a cascade of VPH notch filters each being designed and disposed so that the target wavelength component is attenuated. In each case, the notch filter system of the present invention includes an appropriate optical assembly to direct the light signal through the system. Both strategies mentioned above will be explained in more detail below through the description of various preferred embodiments of the invention.

### Cascade Notch Filter System

With reference to FIG. 1A, in accordance with one aspect of the invention, there is provided a cascade notch filter system (10A) for removing a target spectral component from a light signal (14). The cascade notch filter system (10A) includes multiple notch filters (12), preferably volume phase holographic notch filters (VPH), arranged in a cascade. Cascade is used herein to mean a series of elements, that is to say, more than two elements arranged in succession. Each of the notch filters (12) is disposed in the path of the light signal (14) and adjusted to an appropriate Bragg condition for affecting the rejection of a single fixed wavelength. The operation principle of this type of filter is based on the well known Bragg's Law, according to which the rejected Bragg wavelength λ_{B} is determined from:

λ_{B}=2Λn sin θᵢ, for transmissive VPH

and

λ_{B}=2Λn cos θᵢ, for reflective VPH

where n is the refractive index of the filter, Λ is the index modulation period and θᵢ is the angle of the incoming light with respect to the normal of the Bragg planes. It can therefore be understood that the rejected wavelength will depend both on the spectral filtering characteristics of a given filter, determined by intrinsic factors such as n and Λ, and by the incidence angle of the light signal. The notch filters (12) of the cascade can therefore each be disposed in the path of the light signal (14) so that the light signal forms a filter angle θ with respect to the normal (16) of the notch filter (12) which is selected, in view of the spectral filtering characteristics of the filter, to match the target spectral component with the Bragg condition. As one skilled in the art will understand, the filter angle θ does not necessarily correspond to the incidence angle θᵢ of Bragg's Law, but is directly related thereto.

If the filter is used in transmissive mode, then only the spectral component which is in alignment with the spectral filtering characteristics of the filter is diffracted by the filter and removed from the light signal, the remaining light signal passing through the filter undiffracted. If the filter is used in reflective mode, then the spectral component which is in alignment with the spectral filtering characteristics of the filter is reflected by the filter and removed from the light signal, the remaining light signal passing through the filter.

In operation, for the cascade notch filter system as shown in FIG. 1A, incoming light (14) is incident on a first VPH notch filter (12). The spectral content of the incoming light (14) which does not meet the Bragg condition is transmitted by the VPH notch filter (12) unaffected. Within the spectral region corresponding to the target spectral component, a portion (16) of the light signal is rejected by the VPH notch filter (12), but another portion is transmitted along with the remainder of the signal, as the optical density of the filter is insufficient to completely filter out the target spectral component. The transmitted light is then incident on a second VPH notch filter (12) where the same process occurs thus further attenuating the unwanted target spectral component in the transmitted light signal. By making the light signal undergo multiple filter passes, the attenuation of the unwanted spectral component is enhanced; the greater the number of VPH notch filters (12) through which the light signal passes, the greater the optical density of the system as a whole and thus the greater the attenuation of the unwanted spectral component.

As explained above, attenuation in this type of filter is accomplished by reflecting or diffracting the wavelength component or components which meet the Bragg condition of the Bragg planes of the VPH filter (12), i.e. the Bragg condition set up by the periodic modulation of the refractive index of the VPH filter (12). As the Bragg condition depends on the angle of incidence of light on the Bragg planes, the nature of the reflected wavelength component will also depend on the angle of incidence of the light signal on each VPH notch filter (12). In one embodiment of the invention, all the VPH notch filters (12) are of the same construction, that is, they all have the same intrinsic spectral filtering characteristics. In such a case, in order to all reflect a same wavelength component they all receive the light signal at substantially the same incidence angle, and the angles θ, θ′, θ″, and θ′″ shown in FIG. 1A are all the same. It is preferable to avoid placing the different filters parallel to each other, as this would lead to Fabry-Perot cavity effects damaging to signal rejection. There is however a great number of other possible of orientation of the filters which avoid this situation, as all the possible directions of incidence of the light beam forming a same filter angle θ on a given VPH notch filter (12) define a cone having a central axis aligned with the normal to the filter. Preferably, the normal (16) of each VPH notch filter (12) lies at a minimal distance to each other so that tilting the ensemble of VPH notch filters (12) with respect to the incoming light (14) produces a similar angular change for all of the VPH notch filters (12).

Alternatively, in another preferred embodiment, the VPH notch filters may not be identical and therefore have spectral characteristics differing from one to the other, in which case the filter angle θ can vary from filter to filter. In this case, the angles θ, θ′, θ″, and θ′″ shown in FIG. 1A would not all be the same. Of course, the spectral characteristics and filter angle θ associated with each VPH notch filter (12) should still be selected so that the Bragg condition is met for the target wavelength component. Mixed embodiments where some of the notch filters (12) are identical and some are different could also be considered.

Advantageously, the notch filter system (10A) may include tuning means. As shown in the embodiment illustrated in FIG. 1B, the notch filter system (10A) may be placed in a holder (19a). Preferably, the holder rests on a dual-axis tilt mechanism (19b). The mechanism allows for the adjustment of the angular position of the individual VPH notch filters (12) with respect to each other and the incoming light (14) for maximising the rejection Bragg condition and also providing a mean for compensating for minor temperature variations. According to another variant, the effects of temperature variation on the optical performance of the notch filter system (10A) may be minimised by encapsulating the entire notch filter system (10A) in an athermal package.

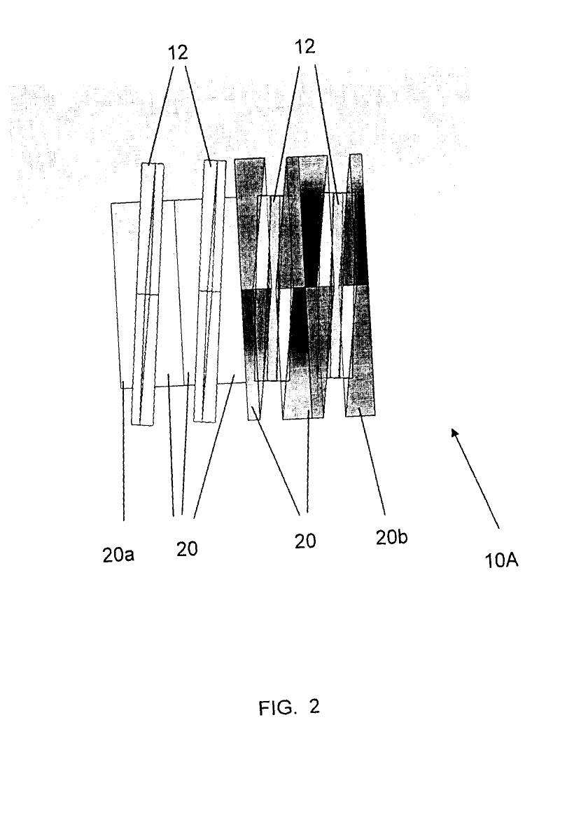

Referring to FIG. 2, there is shown another embodiment of the invention. In this particular case, to avoid Fresnel losses due to changes in index of refraction as the light travels from one medium to the next, e.g. from air or vacuum into a VPH notch filter (12), index-matching prisms (20) are preferably placed in the gap (18) “sandwiched” between the VPH notch filters (12) of the notch filter system (10A). Additional prisms (20) may be placed before and after the cascade of VPH notch filters (12). The function of the first prism (20a) is to have a notch filter with the entrance facet perpendicular to the incoming light beam and that of the last prism (20b) is to ensure that the output light beam will exit the filter parallel to the axis of the incoming light beam. Alternatively, the notch filter system may be encapsulated in a case filled with an index-matching liquid.

Preferably, the notch filter system (10A) may include additional corrective optics, e.g. a prism, placed before and/or after the cascade of VPH filters (12) so as to align the incident light with the filtered light, i.e. to keep the light on-axis.

As will be understood by one skilled in the art, any additional components may be used in the notch filter system to direct or otherwise transform the light signal at any point therethrough. These additional components and the components defined above are collectively referred to herein as an appropriate optical assembly.

### Multipass Notch Filter System

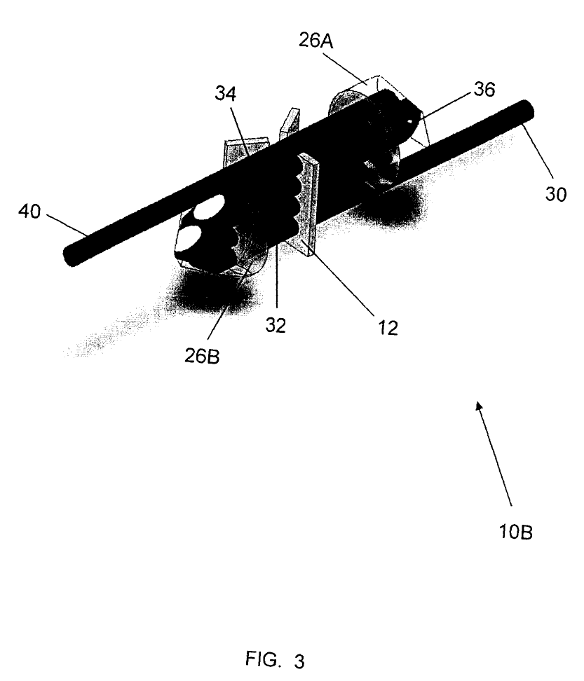

Referring to FIGS. 3 to 6, there are shown alternative embodiments of a second aspect of the present invention where the light signal makes multiple passes through a same VPH notch filter. In such a multipass notch filter system, the optical assembly is designed to ensure that the light signal is incident with the same incidence angle (filter angle with respect to a normal of the notch filter) on the VPH notch filter at each pass. The use of prism cube corners is preferably shown for this purpose in the appended drawings, but other reflective components or combination of components could alternatively be used.

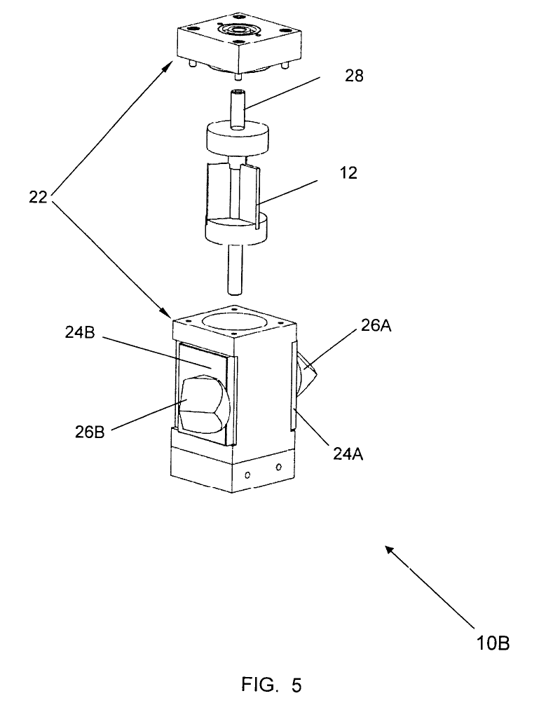

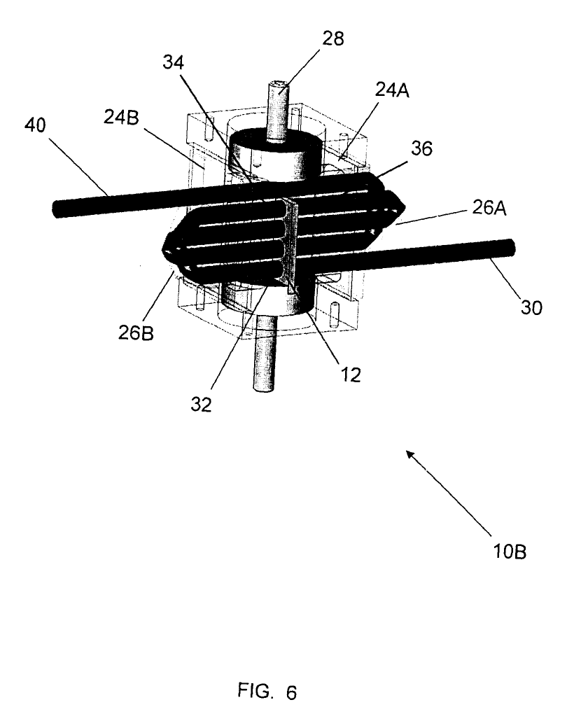

In one embodiment of the multipass notch filter system (10B), illustrated in FIGS. 5 and 6, system (10B) includes a leak-tight cell (22), preferably filled with an index matching liquid (not shown for sake of clarity) to avoid Fresnel reflections, and at least one VPH notch filter (12). The leak-tight cell (22) has two parallel transparent walls (24A and 24B) for receiving incoming light and transmitting filtered light. The transparent walls (24A and 24B) include the reflective components, such as prism cube corners (26A and 26B).

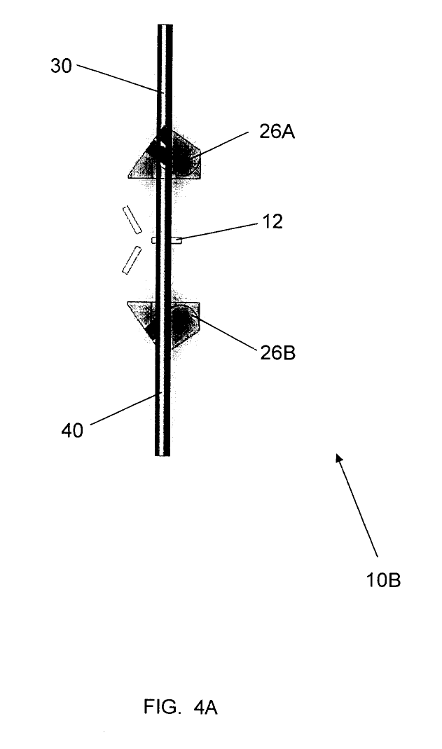

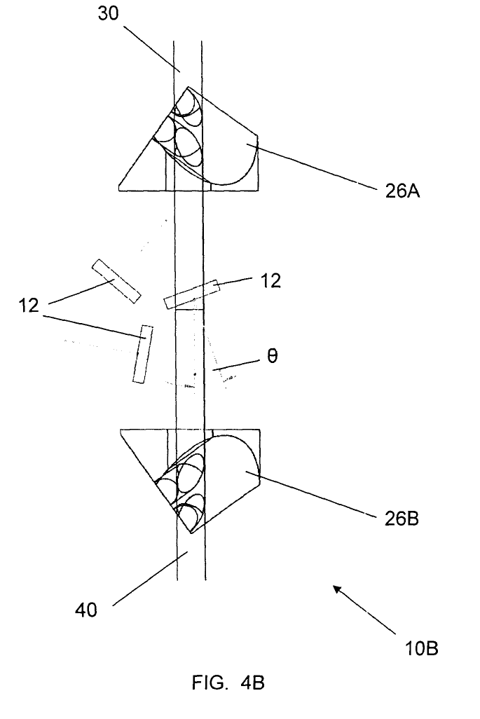

In accordance with this second aspect of the invention, the multipass notch filter system (10B) may advantageously be tunable in rejection wavelength. This may be simply accomplished by rotating the notch filter (12) about a rotation axis perpendicular to the propagation of the light beam therethrough. Any rotation of the filter with respect to this axis will modify the filter angle θ in the same manner on both sides of the notch filter, thereby changing the wavelength for which the Bragg condition is met, as shown in FIG. 4B. In one embodiment (not shown), the filter may be rotated on itself.

In another embodiment, as shown in FIGS. 3 to 6, the multipass notch filter system (10B) may includes a plurality of VPH notch filters (12), each preferably having different spectral filtering characteristics mounted on a rotating filter mount to adapted to move either one of the notch filters in the path of the light signal. The rotating filter mount may be embodied by a rotation shaft (28) that runs vertically through the leak-tight cell (22), provided with appropriate means to control its orientation (not shown). The VPH notch filters (12) are mounted on the rotation shaft (28) and are submersed in the index-matching liquid contained in the leak-tight cell (22). In the embodiments of FIGS. 3 and 5, the rotation shaft (28) is shown as having three VPH notch filters (12) mounted thereon, but other configurations could of course be considered. As can be seen more clearly from the embodiments illustrated in FIGS. 4A and 4B, the filtered wavelength component could depend both on which filter is in the path of the light beam, and on the angle between the light signal and the normal of this filter, allowing a wide selection of rejection bands and illustrating the versatility of the present notch filter system.

In operation, the incoming light signal (30) has preferably already been collimated so that its divergence is less than the angular acceptance of the Bragg condition which is of the order of millirads (mrad). The collimated incoming light (30) enters the leak-tight cell (22) through one of the transparent walls (24A), passes through the index-matching liquid and impinges a first time one of the VPH notch filter (12) mounted on the rotation shaft (28), as shown in FIG. 6. The angle of incidence defined by the impinging light and the normal to the VFH notch filter (12) determines the center wavelength of the rejection wavelength band undergoing Bragg diffraction. A portion of the unwanted target spectral component of the light signal (30) is removed through reflection or diffraction by the VPH notch filter (12), but the remainder of the light signal (30) does not satisfy the resonance Bragg condition and consequently is transmitted, passing through the VPH notch filter (12) unaffected. The unwanted spectral component is however only attenuated by the VPH notch filter (12) since a portion of the unwanted spectral component of the light signal is actually also transmitted. The transmitted light (32) with the attenuated unwanted spectral component reaches the reflection means, the retroreflector prism cube corner (26B), where it is reflected and displaced by the cube corner (26B) back towards the VPH notch filter (12). Once again, the wanted spectral components of the reflected light (34) are transmitted through the VPH notch filter (12) and the unwanted spectral components are further attenuated. Following this second pass through the VPH notch filter (12), the transmitted light (36) reaches the other prism cube corner (26A) and is reflected back towards the VPH notch filter (12) for a third pass. This is repeated several times so that the light signal undergoes multiple filter passes thereby maximising the attenuation of the rejection wavelength band in the final transmitted light signal (40).

Advantageously the present notch filter system can exhibit laser attenuation greater than 40 db (i.e. an optical density greater than 4.0), a spectral bandwidth less than 10 cm⁻¹. In addition, the wavelength range available with this system is from 350 nm to 2500 nm for current PTR glasses, with the tunable version having a tuning range of up to 300 nm. These enhanced properties allow the use of the present notch filter system for applications in Raman spectroscopy, telecommunication, and astronomical imaging, among others.

Numerous modifications could be made to any of the embodiments described above without departing from the scope of the present invention as defined in the appended claims.

1. A cascade notch filter system for removing a target spectral component from a light signal, the cascade notch filter system comprising:
multiple notch filters arranged in a cascade, each of said multiple notch filters having spectral filtering characteristics and being disposed in the path of the light signal so that said light signal forms a filter angle with respect to a normal of the corresponding notch filter, said spectral filtering characteristics and said filter angle being jointly selected for each notch filter so that the target spectral component is filtered out of the light signal as said light signal passes therethrough.

2. The cascade notch filter system according to claim 1, wherein the filtering characteristics and filter angle are different for consecutive notch filters of said cascade.

3. The cascade notch filter system according to claim 1, wherein the filtering characteristics and filter angle are the same for consecutive notch filters of said cascade, said consecutive notch filters extending non-parallel to each other.

4. The cascade notch filter system according to claim 1, wherein each one of the multiple notch filters is a volume phase holographic notch filter.

5. The cascade notch filter system according to claim 4, wherein the volume phase holographic notch filter comprises photosensitive glass material.

6. The cascade notch filter system according to claim 1, further comprising tuning means for tuning the target spectral component filtered out by said system, the tuning means comprising a holder for holding and jointly adjusting the filter angle of all of the multiple notch filters.

7. The cascade notch filter system according to claim 1, further comprising index-matching prisms sandwiched between consecutive notch filters of said multiple notch filters.

8. The cascade notch filter system according to claim 1, further comprising a first prism positioned before the cascade of notch filters for providing an entrance facet that is perpendicular to the light signal, and a last prism positioned after the cascade of notch filters for ensuring that the light signal at an exit of the cascade of notch filters is parallel to the light signal at an entrance of the cascade of notch filters.

9. The cascade notch filter system according to claim 1, further comprising a case filled with an index-matching liquid encapsulating the cascade of notch filters.

10. A multipass notch filter system for removing a target spectral component from is a light signal, the multipass notch filter system comprising:
a notch filter having spectral filtering characteristics; and
an optical assembly for directing the light signal through the notch filter for multiple passes, said optical assembly directing the light beam onto the notch filter at a same filter angle with respect to a normal of the notch filter at each of said multiple passes, said spectral filtering characteristics and said filter angle being jointly selected so that the target spectral component is filtered out of the light signal as the light signal passes through the notch filter.

11. The multipass notch filter system according to claim 10, wherein said optical assembly comprises a pair of reflective components positioned on either side of the notch filter.

12. The multipass notch filter system according to claim 11, wherein said at least one reflective component is a prism cube corner.

13. The multipass notch filter system according to claim 10, wherein the notch filter is a volume phase holographic notch filter.

14. The multipass notch filter system according to claim 10, further comprising a leak-tight cell encapsulating the notch filter and optical assembly, the leak-tight cell including two parallel transparent walls for receiving the light signal and outputting a filtered light signal, said leak-tight cell being filled with an index matching liquid.

15. The multipass notch filter system according to claim 10, further comprising a rotating filter mount for mounting the notch filter thereon and rotating the notch filter about a rotation axis of the notch filter to position the notch filter in a path of the light signal.

16. The multipass notch filter system according to claim 10, further comprising additional notch filters and a rotating filter mount for mounting the notch filter and the additional notch filters thereon and moving one of the notch filters in a path of the light signal.
